(19) United States
(12) Patent Application Publication
(10) Pub. No.: US 2007/0262556 A1
(43) Pub. Date: Nov. 15, 2007

(54) Clamping Method and Device for the Front Wheel of a Vehicle Like a Motobike, a Bicycle or Suchlike

(76) Inventor: Massimo Danelutti, Goricizza di Codroipo (UD) (IT)

Correspondence Address: HAMRE, SCHUMANN, MUELLER & LARSON, P.C., P.O. BOX 2902, MINNEAPOLIS, MN, 55402-0902, US

(21) Appl. No.: 11/791,569

(22) PCT Filed: Nov. 24, 2005
(86) PCT No.: PCT/IB05/03543

§ 371 Date: May 24, 2007

(30) Foreign Application Priority Data
Nov. 25, 2004 (IT) UD2004A000230

(51) Int. Cl. B62K 25/02

(52) U.S. Cl. 280/276

(57) ABSTRACT

A clamping device to removably assemble a front wheel on a fork of a vehicle, in particular a motorbike, wherein the front wheel is able to rotate on its own rotation pin. The clamping device comprises a pair of support elements, associated with the fork, on opposite sides with respect to the position of the front wheel, and each provided with an aperture able to house the rotation pin. Positioning elements are provided with a seating for the rotation pin and are able to be disposed in the aperture, so that the seating of the rotation pin assumes a determinate position, selectively adjustable, with respect to the fork, in order to consequently regulate also the position of the rotation pin with respect to the fork and the trail of said front wheel.

### FIELD OF THE INVENTION

The present invention concerns a clamping method and the relative device to removably assemble a wheel to the front fork of a vehicle, like a motorbike, a bicycle or suchlike.

### BACKGROUND OF THE INVENTION

A clamping device is known which is used to removably assemble a wheel on the front fork of a motorbike, either on-road or off-road, but possibly also on the front fork of a bicycle.

The front fork comprises two suspensions, disposed parallel and separated from each other, and a pair of plates, pivoted on a steering pin and able to connect the upper ends of the suspensions. In the state of the art, the forks are of the traditional type, wherein the suspensions have a rod in their upper part and a corresponding jacket for the rod in the lower part, or they are of the upside down type, wherein the suspensions have a rod and jacket in an inverted position with respect to the previous type of fork.

The known clamping device, in the case of upside down forks, is assembled at the lower end of the rod of each suspension, while in the case of traditional forks, it is made solid with the lower end of the jacket of the suspension.

In both these solutions, the clamping device comprises two aluminum supports, called feet, on each of which a circular through hole is made, into which a rotation pin of the wheel is able to be inserted, for the univocal attachment of the wheel to the fork. In the case of on-road motorbikes, the hole is mainly made in axis with the suspensions, while in the case of off-road motorbikes the hole is made mainly in a forward position with respect to the axis of the suspensions, in order to guarantee a greater excursion of the front fork, in order to absorb the unevenness of the ground.

In motorbikes provided with disk brakes, a connection element is made on one of the two supports behind said circular seating and is able to connect to said support the caliper of the front brake of the motorbike. In another known solution, if the brake provides to use one or more braking disks on both sides of the wheel, a connection element is made on both supports, so that each of the latter supports a relative caliper of the front brake.

In motorbikes, especially those used in sports competitions, there is a need to effect a plurality of adjustments on the front fork, or on the steering pin, so as to vary the value of the trail, that is, the distance between the projection of the rotation pin on the ground and the intersection between the ground and the extension of the axis of the steering pin. If the value of the trail is high, then the motorbike is more stable along straight stretches but also not very manageable during the changes of direction, and vice versa, if the value of the trail is lower.

Since the pivoting of the wheel is univocal with respect to the fork, in order to adjust the value of the trail it is necessary to modify the position of the fork by varying the disposition of the plates that form the steering tube, so as to vary the interaxis, or offset, between the suspensions and the steering pin, and/or their inclination. These operations are difficult to do, however, and take a lot of time and specialized manpower to do them in the correct way.

The state of the art also includes the following documents: GB-A-181,861; FR-A-2.490.176; U.S. Pat. No. 3,694,004; U.S. Pat. No. 4,455,032; FR-A-2.578.505; JP-A-04-159180; FR-A-2.483.350.

One purpose of the present invention is to achieve a clamping device and perfect a corresponding method which will allow a simple, rapid, effective and precise adjustment of the value of the trail of the motorbike and the interaxis between the wheels and, consequently, the repositioning of the caliper, or calipers, of the front brake according to the position of the wheel pin and the diameter of the braking disk or disks.

Another purpose of the present invention is to achieve a clamping device and perfect a corresponding method which will allow to adjust the value of the trail of the motorbike, keeping the inclination of the suspensions constant, or to vary the inclination of the suspensions restoring the original values of trail and interaxis.

The Applicant has devised, tested and embodied the present invention to overcome the shortcomings of the state of the art and to obtain these and other purposes and advantages.

### SUMMARY OF THE INVENTION

The present invention is set forth and characterized in the main claims, while the dependent claims describe other characteristics of the invention or variants to the main inventive idea.

In accordance with the above purposes, a clamping device according to the present invention is used to removably assemble a wheel, rotatable on its own rotation pin, to the front fork of a motorbike.

According to a characteristic of the present invention, the clamping device comprises positioning means able to define a seating for the rotation pin.

The seating is able to be disposed in a determinate position, which is selectively adjustable with respect to the fork.

In a first form of embodiment of the invention, the clamping device also comprises a pair of support elements each provided with an aperture, able to house one end of the rotation pin of the wheel, and the positioning means comprises bushing means disposed in said aperture and defining said seating for the rotation pin.

Each seating is able to be disposed in a predetermined position with respect to the aperture so as to position the rotation pin in a determinate position with respect to the fork. Each position of the rotation pin of the wheel on the fork corresponds to a pre-determinate value of the trail of the motorbike, and hence to corresponding performances of the latter in terms of stability on the straight and handling in the changes of direction.

In a preferential form of embodiment, the aperture is substantially an eyelet, made on the support in a substantially horizontal or inclined or vertical position, or has a substantially polygonal shape.

According to a first variant, the bushing means comprises a series of shaped bushings, able to be housed selectively, without play, inside said eyelet and each having their own seating disposed so as to correspond to a determinate value of the trail.

In a second variant, the positioning means comprises a cylindrical or polygonal bushing, which is disposed in said aperture with play and whose position in the aperture is defined by means of a first screw, screwed onto a first end of the aperture, and a second screw, screwed onto a second end of the aperture.

The screws clamp the cylindrical bushing between them, and their progressive screwing or unscrewing allows to position the cylindrical or polygonal bushing in a predetermined position in the aperture corresponding to a determinate value of the trail.

According to another variant, each support element also comprises an auxiliary element, assembled on its front part and defining said aperture with the support element.

An adjustment means is interposed between the front part of the support element and the auxiliary element so as to adjust the position of the aperture with respect to the fork.

In another form of embodiment of the present invention, each support element, during use, comprises an upper part, assembled on the fork, and a lower part, which is assembled on the upper part and on which the seating is made for the rotation pin of the wheel.

The positioning means comprises adjustment means which allows to adjust the position of the lower part on the upper part, and consequently to adjust the position of the rotation pin with respect to the fork according to a determinate value of the trail.

The adjustment means advantageously comprises at least a spacer, interposed between a vertical wall of the upper part and a mating shoulder of a seating, made on the lower part so as to house the upper part. Depending on the thickness of the spacer, it is possible to assemble the lower part on the upper part in a determinate position depending on the desired value of the trail.

To be able to achieve a snap-in positioning of the lower and upper parts, a plurality of teeth are made on the bottom of the seating, and a mating plurality of hollows for said teeth are made on the lower wall of the upper part. In this way, the positioning of the lower part on the upper part is very stable and, during use, no unwanted sliding of one part with respect to the other occurs.

On at least one support element a connection means is made, able to connect braking means to the support element itself. A second adjustment means is advantageously able to adjust the position of the braking means on the support element, according to the position of the rotation pin of the wheel on the fork and also, possibly, according to the diameter of the brake disk used.

The method to clamp the wheel to the front fork of the motorbike comprises a first positioning step in which the seating is defined for the rotation pin, and a second positioning step in which the seating is disposed in a determinate position, which can be adjusted with respect to the fork.

To be more exact, if the positioning means comprises the bushing means, in the first positioning step said bushing means is disposed inside the aperture of each support element, so as to define the seating for the rotation pin, and in the second positioning step the rotation pin is disposed in the corresponding seating of each support element and, consequently, is positioned with respect to the fork according to a determinate value of the trail.

A third assembly step provides to position braking means on connection means made on at least a support element behind the aperture. A second adjustment means is disposed on the connection means in order to adjust the position of the braking means on the support element.

If the bushing means comprises the series of shaped bushings, prior to the first positioning step a step is provided to select the shaped bushings and the correlated second adjustment means according to a determinate value of advance of the rotation pin, the trail and the interaxis between the wheels of the motorbike. The selection of the shaped bushings and the second adjustment means is made using for example a specific table.

The clamping method and device according to the present invention allow to adjust, simply, rapidly and precisely, the value of advance, the trail and the interaxis between the wheels and, consequently, to obtain the desired performance of the motorbike.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a lateral schematic view of the front fork of a motorbike with the clamping device according to the present invention;

FIG. 2 is a section from II to II of FIG. 1;

FIG. 3 is a partly sectioned lateral view of the clamping device according to the present invention;

FIGS. 4 to 6 show different variants of a detail of FIG. 3;

FIG. 7 is a partly sectioned lateral view of a first variant of FIG. 3;

FIG. 8 is a section of a variant of a detail of FIG. 7;

FIG. 9 is a partly sectioned lateral view of a second variant of FIG. 3;

FIGS. 10 to 14 are exploded views that show other variants of FIG. 3;

FIG. 15 is a plane view of another form of embodiment of the device according to the present invention;

FIG. 16 is a lateral view partly sectioned along the line from XVI to XVI of FIG. 15;

FIG. 17 is a partly sectioned lateral view of a first variant of FIG. 15;

FIG. 18 is a partly sectioned lateral view of a second variant of FIG. 15;

FIG. 19 is a lateral view partly sectioned along the line from XIX to XIX of FIG. 18;

FIG. 20 is a table for choosing the clamping device according to the present invention according to the desired trail and an exploded view of said device.

### DETAILED DESCRIPTION OF A PREFERENTIAL FORM OF EMBODIMENT

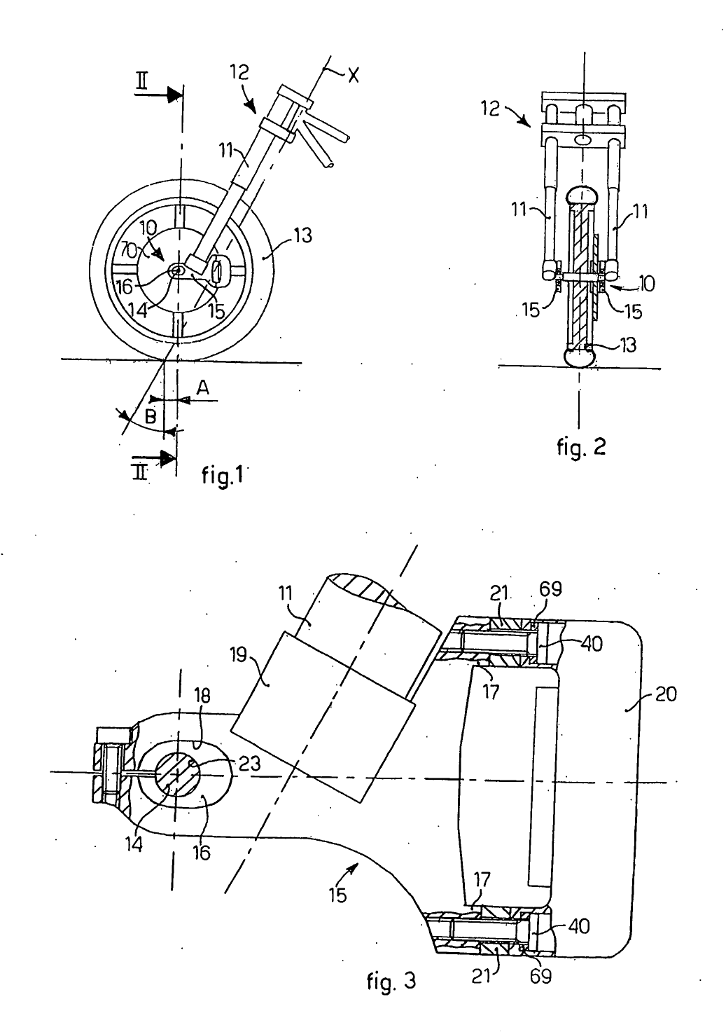

With reference to FIGS. 1, 2 and 3, a clamping device 10 according to the present invention is assembled on the lower ends of the suspensions 11 of the front fork 12 of a motorbike and allows to pivot to said fork 12, in different predetermined positions, a wheel 13 by means of a rotation pin 14. In this case, the motorbike is of a substantially known type and is suitable for off-road driving, and the fork 12 is of the upside down type, that is, each suspension 11 has the rod in its lower part, and in its upper part the jacket relative to the rod.

The clamping device 10 comprises a pair of aluminum supports 15, called feet, each one provided with a corresponding positioning bushing 16.

A circular seating 19, able to house the lower end of the corresponding suspension 11, and a through eyelet or aperture 18, disposed in front of the circular seating 19, which houses the corresponding bushing 16 without play, are made in a single piece on each support 15.

A through hole, or seating 23, is made on each bushing 16, in a suitably chosen position, into which the rotation pin 14 is inserted. When the bushing 16 is inserted into the aperture 18, the corresponding seating 23 thus finds itself in a predetermined position inside the aperture 18, so that the wheel 13 is pivoted to the fork 12 of the motorbike according to a predetermined value A of the trail. The trail is defined as the distance between the projection on the ground of the axis of the rotation pin 14 of the wheel 13 and the point of intersection between the ground and the axis of rotation X of the fork 12 with respect to the frame of the motorbike, which axis X is inclined by an angle β with respect to a substantially vertical plane.

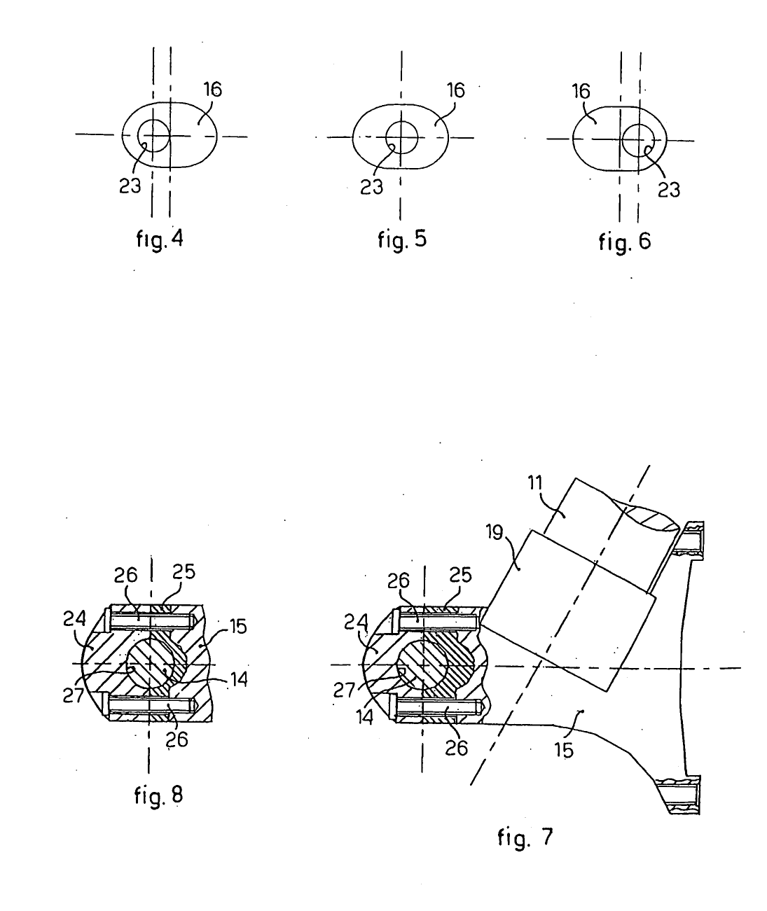

As shown in FIGS. 4 to 6, the seating 23 can be made in different positions on the bushing 16, also displaced by a few microns with respect to each other, and/or with different diameters, so as to allow the user to use the most suitable bushing 16 both to achieve a predetermined value A of the trail, and also according to the diameter of the rotation pin 14.

On the support 15, assembled on the left-hand suspension 11 of the fork 12 (FIGS. 2 and 3), two holed caliper-bearing elements 17 are made, behind the circular seating 19 and suitably distanced from each other. They are used to assemble on the clamping device 10, by means of screws 40, in a position substantially radial with respect to the wheel 13, a caliper 20 of a known disk-type braking device.

Two spacers 21, substantially cylindrical in shape, are interposed between the corresponding caliper-bearing elements 17 and the caliper 20, so as to move the caliper 20 closer to or away from the clamping device 10 according to their thickness. The thickness of the spacers 21 is chosen according to the position of the wheel 13 on the fork 12, hence according to the bushing 16 and the diameter of a disk 70 of the brake used.

A washer 69 is also interposed between the head of each screw 40 and the caliper 20, so as to guarantee that the head of the screw 40 always abuts on the caliper 20 whatever the thickness of the spacers 21 may be.

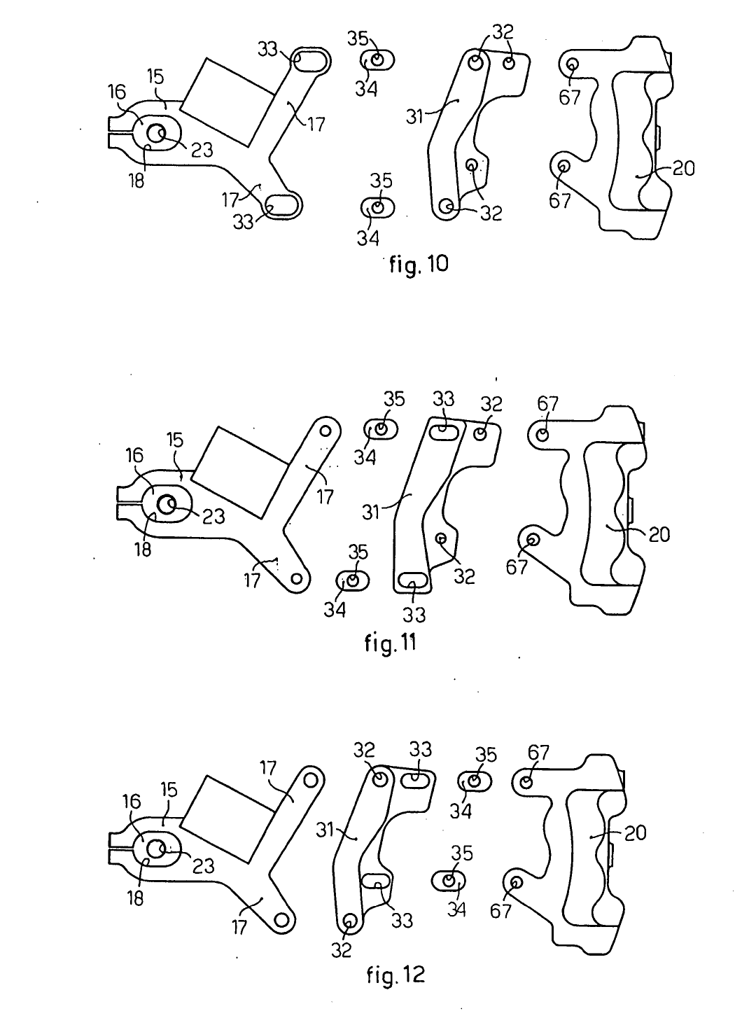

In another solution, shown in FIG. 10, the caliper 20 can be attached to the caliper-bearing elements 17 in a direction substantially axial with respect to the wheel 13. In this solution, between the caliper-bearing elements 17 a plate 31 is positioned, which comprises two pairs of through holes 32; a first pair of the holes 32 allows to assemble by means of screws the plate 31 on the caliper-bearing elements 17, while the second pair of holes 32 is mating with a pair of holes 67 made on the caliper 20 and allows the caliper 20 to be assembled by means of screws on the plate 31. To be more exact, the plate 31 allows to assemble the caliper 20 on the caliper-bearing elements 17, whatever the interaxis may be between two holes 67 made on the caliper 20.

On each caliper-bearing element 17 a through eyelet 33 is made, which houses without play a corresponding bushing 34; on the latter a through hole 35 is made in a position correlated to that of the seating 23 made on the bushing 16, housed on the aperture 18.

The caliper 20 is assembled by means of the bushing 34 on the caliper-bearing elements 17 in a position corresponding to the value of the trail obtained by means of the bushing 16.

According to a first variant of this embodiment, shown in FIG. 11, two eyelets 33 are made on the plate 31 instead of the pair of through holes 32 mating with the caliper-bearing elements 17, while in a second variant, shown in FIG. 12, the two eyelets 33 are made instead of the second pair of through holes 32, corresponding to the holes 67 made on the caliper 20.

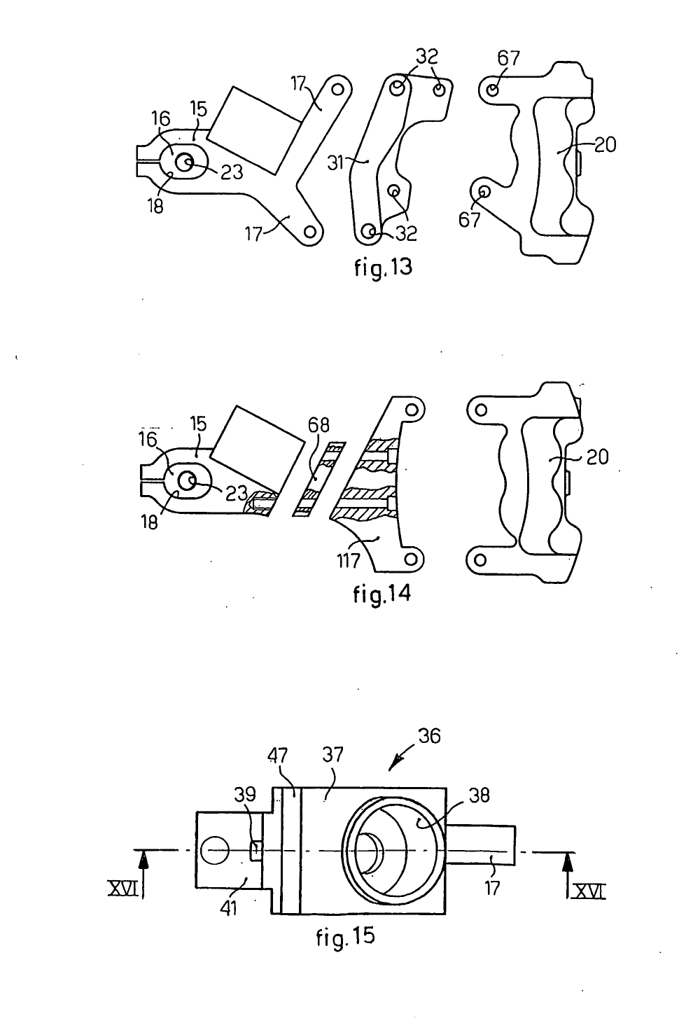

In a third variant, shown in FIG. 13, the two pairs of through holes 32 are made on the plate 31 with an interaxis which depends on the value of the trail desired.

In another variant, shown in FIG. 14, a caliper-bearing element 117 is assembled on the support 15 and the caliper 20 of the braking device is assembled thereon in an axial direction but, in a case not shown, in a radial direction too. A spacer 68 is interposed between the caliper-bearing element 117 and the support 15 so as to position the element 117 on the support 15 according to the desired value of the trail.

The clamping device 10 is supplied in a kit comprising the two supports 15, a series of pairs of bushings 16, each having the through hole 23 made in a determinate position and with a determinate diameter, and a plurality of pairs of spacers 21, washers 69 and screws 40, corresponding to a determinate pair of bushings 16.

Moreover, a table 22 (FIG. 20) is supplied with the kit and in this case allows to determine, according to a predetermined value A of the trail, the most appropriate pair of bushings 16, the pair of spacers 21, the pair of washers 69 and the pair of screws 40.

If the kit also comprises bushings 34, plates 31, and spacers 68, the table 22 also allows to select these bushings 34, plates 31, and spacers 68, corresponding to the pair of bushings 16 chosen.

The method to clamp the wheel 13 to the fork 12 of the motorbike comprises in sequence the following steps.

Firstly, according to the value A of the desired trail and diameter of the disk 70 of the brake (FIG. 20), the user selects the pair of bushings 16 and the relative pair of spacers 21, washers 69 and screws 40, according to the value A of the trail desired and the diameter of the disk 70 of the brake, consulting the table 22 provided with the kit.

At this point a step is performed to position the chosen pair of bushings 16 in the corresponding aperture 18 of both supports 15.

Once the bushings 16 have been positioned, a step is performed to position and attach the ends of the rotation pin 14 inside the corresponding through hole 23 of each bushing 16.

When this operation is finished, the caliper 20 is connected to the corresponding support 15 by means of the caliper-bearing elements 17, or 117, and the corresponding pair of spacers 21, washers 69 and screws 40, depending on whether the assembly of the caliper 20 of the braking device is to be done in an axial or radial direction.

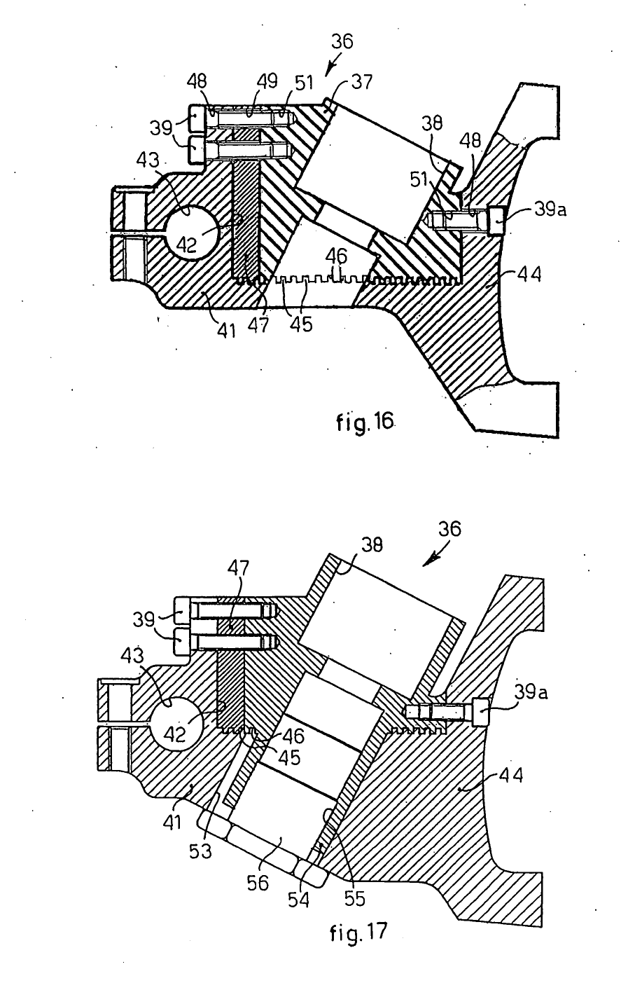

In a variant of the invention, shown in FIGS. 15 and 16, the clamping device 10 comprises a pair of supports 36, each of which is assembled on the lower part of the corresponding suspension 11 of the fork 12.

Each support 36 comprises an upper part 37, provided with a circular seating 38 able to house the lower part of the suspension 11; and a lower part 41, assembled below the upper part 37.

In a single piece on the lower part 41 are made a seating 42, which houses the upper part 37, a through hole 43, obtained in front of the seating 42 and which defines the seating inside which the rotation pin 14 of the wheel 13 is at least partly housed, and a caliper-bearing element 44, obtained behind the seating 42 and supporting the caliper 20 of the braking device.

The bottom of the seating 42 comprises a plurality of teeth 45 which, during use, are inserted in a mating plurality of hollows 46, made on the lower wall of the upper part 37, so as to position, in snap-in manner, stably and precisely, the lower part 41 on the upper part 37 and, consequently, to position the rotation pin 14 with respect to the fork 12 in order to thus obtain a desired value of the trail.

A spacer 47, on the lower wall of which the seatings 46 are made, is interposed between a lateral wall of the upper part 37 and a mating shoulder of the seating 42, so that between the shoulder and the vertical wall there is no play.

A plurality of screws 39 and 39a allow to attach the lower part 41 on the upper part 37 after the lower part 41 has been positioned thereon.

To be more exact, two screws 39 each pass through corresponding through holes 48 and 49, made respectively on the lower part 41 and the spacer 47, and are screwed into corresponding threaded holes 51 made on the upper part 37.

A screw 39a passes through another through hole 48 and is screwed into a corresponding threaded hole 51 made in the upper part 37 thus achieving, in cooperation with the two screws 39, the lateral clamping of the lower part 41 on the upper part 37.

Another plurality of screws, not shown here, each of which passes through a corresponding eyelet, made on the bottom of the lower part 41, and screws into the upper part 37, clamp the upper part 37 onto the bottom of the seating 42.

According to a first variant, shown in FIG. 17, a through hole 53, having its axis parallel to the axis of the suspension 11, is made below the seating 42 and houses with play a mating cylindrical element 54, made in a piece on the upper part 37 and provided with a threaded hole 55, into which a corresponding screw 56 is screwed.

The play between the through hole 53 and the mating cylindrical element 54 allows to position the lower part 41 on the upper part 37 according to a determinate value of the trail.

The screwing of the screw 56 into the corresponding threaded hole 55 allows to attach the lower part 41 from below onto the upper part 37.

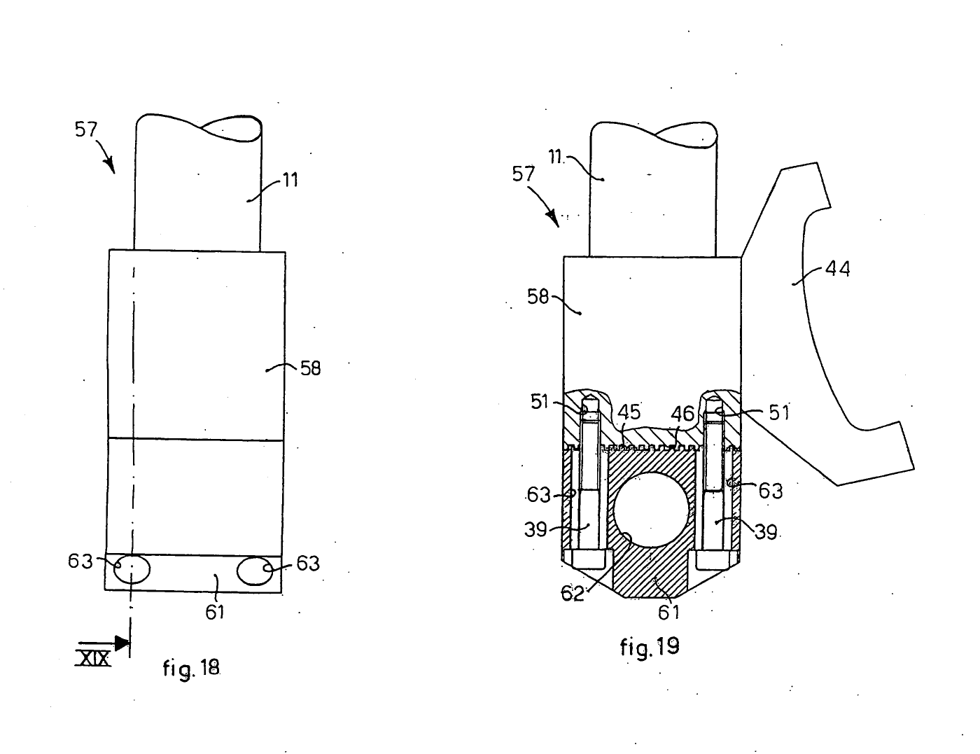

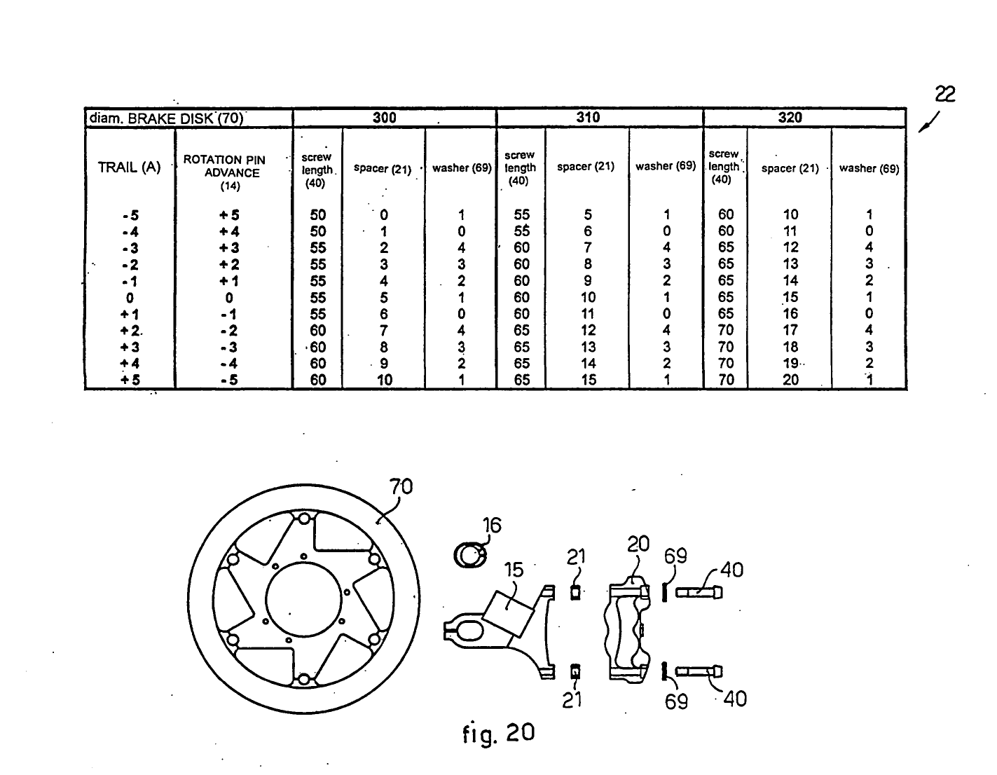

In a second variant of the invention, shown in FIGS. 18 and 19, a support 57 comprises an upper part 58, on which the caliper-bearing element 44 is made in a piece, and a lower part 61, assembled on the upper part 58 and on which, in axis with the suspension 11 of the fork 12, a through hole 62 is made, which defines the seating which houses the rotation pin 14 of the wheel 13.

On the adjacent faces of the upper part 58 and the lower part 61 the plurality of teeth 45 and the corresponding hollows 46 are respectively made, so as to be able to position in snap-in manner the lower part 61 on the upper part 58 in a determinate position according to the value of the trail.

The lower part 61 is attached on the upper part 58 by means of four screws 39, each of which passes through a corresponding through eyelet 63 made on the lower part 61, and is screwed into a corresponding threaded hole 51, made on the upper part 58.

In a third variant of the invention, not shown here, on the adjacent surfaces of the lower part 61 and upper part 58 a slider and a mating guide are respectively made, in order to allow to position the lower part 61 on the upper part 58 in a determinate position.

It is clear that modifications and/or additions of parts may be made to the clamping device 10 as described heretofore, without departing from the field and scope of the present invention.

For example, (FIGS. 7 and 8), each support 15 comprises an auxiliary part 24, able to be assembled on the front part by means of two screws 26. The auxiliary part 24 and the front zone of the support 15 are shaped so as to define, in correspondence with their zone of contact, a seating formed by a through hole 27, or an eyelet, able to house the rotation pin 14 of the wheel 13.

In this embodiment, a shaped spacer 25 is provided, made in different thicknesses, which is interposed between the support 15 and the auxiliary part 24 so as to move the through hole 27 closer to, or farther from, the circular seating 19, and thus position the wheel 13 on the fork 12 according to a predetermined value A of the trail.

According to a variant not shown here, the through hole 27 can be made on the auxiliary part 24, not requiring the use of shaped spacers 25.

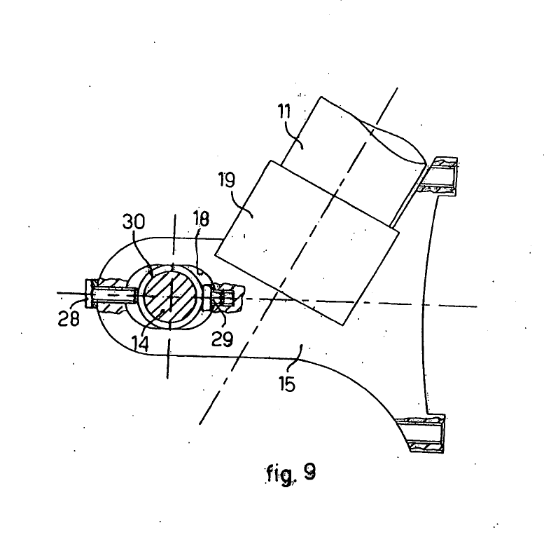

It also comes within the field of the present invention to provide that, as shown in the variant in FIG. 9, two screws 28 and 29 are screwed respectively into the left and right ends of the aperture 18 of each support 15, so as to be able to clamp inside the latter a cylindrical bushing 30 into which the rotation pin 14 is inserted.

The progressive and coordinated screwing or unscrewing of the screws 28 and 29 allows to displace the cylindrical bushing 30, and consequently the rotation pin 14, to the left or right, thus reducing or increasing the value A of the trail.

A plurality of reference notches, not shown here, are made below the aperture 18, so as to allow the correct positioning of the cylindrical bushing 30 on the aperture 18.

In a variant, not shown here, the bushing used can have for example a rectangular profile, so as to guarantee a greater contact surface for the screws 28 and 29, and the eyelet too can have a rectangular shape.

According to another variant, not shown here, the bushing used is of the eccentric type, so as to be able to modify, simultaneously horizontally and vertically, the position of the rotation pin 14 with respect to the fork 12.

According to a variant of the invention, not shown here, the aperture 18 can be made in a vertical position, so as to be able to adjust the position of the wheel 13 in height.

It is also clear that, although the present invention has been described with reference to some specific examples, a person of skill in the art shall certainly be able to achieve many other equivalent forms of method and device to clamp the front wheel of a vehicle like a motorbike, a bicycle or suchlike, having the characteristics as set forth in the claims and hence all coming within the field of protection defined thereby.

1. A clamping device to removably assemble a front wheel on a fork of a vehicle, in particular a motorbike, wherein said front wheel is able to rotate on its own rotation pin, wherein said clamping device comprises a pair of support elements, associated with said fork, on opposite sides with respect to the position of said front wheel, and each provided with an aperture able to house said rotation pin, and bushing means able to be disposed in the corresponding aperture of each support element, and wherein each bushing means is provided with a seating disposed in a determined position with respect to said aperture to house one end of said rotation pin, so that said seating assumes a determinate position, selectively adjustable, with respect to said fork, in accordance with the position of said seating with respect to said aperture, in order to consequently adjust also the position of said rotation pin with respect to said fork and the trail of said front wheel.

2. A clamping device as in claim 1, wherein braking means is associated with at least one of said support elements and wherein the position of said braking means with respect to said fork is correlated to the position of said seating and of said rotation pin with respect to said fork.

3. A clamping device as in claim 2, wherein said aperture has the form of an eyelet.

4. A clamping device as in claim 2, wherein said aperture is polygonal in shape.

5. A clamping device as in claim 1, wherein said bushing means comprises a series of bushings shaped so as to have externally the form of said aperture, and able to be selectively housed without play in said aperture.

6. A clamping device as in claim 1, wherein said bushing means comprises a bushing of cylindrical or polygonal shape, able to be housed with play in said aperture and wherein a first adjustment means is provided to adjust the position of said bushing with respect to said aperture.

7. A clamping device as in claim 6, wherein said first adjustment means comprises a first screw, screwed in correspondence with a first end of said aperture, and a second screw, screwed in correspondence with a second end of said aperture, said first and second screws being able to contact two opposite ends of said bushing in order to dispose said bushing in a predetermined position in said aperture.

8. A clamping device as in claim 1, further comprising an auxiliary element, assembled on the front part of each of said support elements and cooperating with said front part in order to define said seating.

9. A clamping device as in claim 8, wherein a second adjustment means is able to be interposed between each support element and the corresponding auxiliary element in order to adjust the position of said seating with respect to said fork.

10. A clamping device as in claim 8, wherein said seating is a through hole substantially having the diameter of said rotation pin.

11. A clamping device to removably assemble a front wheel on a fork of a vehicle, in particular a motorbike wherein said front wheel is able to rotate on its own rotation pin, wherein said clamping device comprises a pair of support elements, associated with said fork, on opposite sides with respect to the position of said front wheel, and each provided with an aperture able to house said rotation pin, and wherein each of said support elements comprises:
a) an upper part, assembled on the corresponding lower end of said fork;
b) a lower part assembled on said upper part and on which a first seating is made for said rotation pin; and
c) adjustment means able to adjust the position of said lower part with respect to said upper part, thus adjusting the position of said first seating and of said rotation pin with respect to said fork.

12. A clamping device as in claim 11, wherein said lower part comprises a second seating able to house said upper part.

13. A clamping device as in claim 12, wherein said adjustment means comprises at least a spacer, interposed between a vertical wall of said upper part and a mating shoulder of said second seating.

14. A clamping device as in claim 12, wherein said adjustment means also comprises a plurality of teeth, made on the bottom of said second seating, and a mating plurality of hollows, made on the lower wall of said upper part.

15. A clamping device as in claim 2, wherein on the rear part of at least one of said support elements a connection means is made, able to connect said braking means to said support element.

16. A clamping device as in claim 15, wherein second adjustment means are able to be positioned on said connection means in order to adjust the position of said braking means on said support element, according to the position of said rotation pin on said fork.

17. A method to removably assemble a front wheel on a fork of a vehicle, in particular a motorbike, wherein said wheel is able to rotate on a rotation pin, wherein a pair of support elements, are associated with said fork, on opposite sides with respect to the position of said front wheel, and each provided with an aperture able to house said rotation pin, and wherein said method comprises a first positioning step wherein, bushing means provided with a seating to house said rotation pin and disposed in a determined position with respect to said aperture is inserted in the aperture of each support element, and a second positioning step in which said rotation pin is inserted in the corresponding seatings of said bushing means so that the trail of said front wheel is defined in accordance with the position of said seatings with respect to said aperture.

18. A clamping method as in claim 17, wherein in said first positioning step said bushing means is positioned without play inside said aperture, and wherein in said second positioning step said rotation pin is housed without play in the corresponding seating.

19. A clamping method as in claim 17, further comprising a third step to assemble braking means on connection means made on at least one of said support elements, in said third assembly step, on said connection means adjustment means are disposed, correlated to said bushing means and able to adjust the position of said braking means on said support element.

20. A clamping method as in claim 17, wherein said bushing means comprises a series of shaped bushings, and wherein, before said first positioning step, a preliminary step is provided to select said shaped bushings and the corresponding adjustment means according to the adjustments to be made on said vehicle.

21. A clamping method as in claim 20, wherein the choice of said shaped bushings and said adjustment means is made by consulting a specific table, which reports the different shaped bushings according to the different positionings of said rotation pin with respect to said fork.

22. A method to removably assemble a front wheel on a fork of a vehicle, in particular a motorbike, wherein said front wheel is able to rotate on a rotation pin, wherein a pair of support elements, are associated with said fork, on opposite sides with respect to the position of said front wheel, and each provided with an aperture able to house said rotation pin, and wherein said method comprises:
a first step, wherein each of said support elements is made in such a manner as to comprise an upper part and a lower part on which a seating is made for said rotation pin;
a second step, wherein said upper part is attached on the corresponding lower end of said fork and said lower part is assembled on said upper part and wherein, by means of adjustment means, the position of said lower part is adjusted with respect to said upper part, thus also adjusting the position of said seating and of said rotation pin, with respect to said fork;
and a third step wherein said lower part is clamped to said upper part in said determinate position.

23. A clamping device to removably assemble a front wheel on a fork of a vehicle, in particular a motorbike, wherein said front wheel is able to rotate on its own rotation pin, wherein said clamping device comprises a pair of support elements, associated with said fork, on opposite sides with respect to the position of said front wheel, and each provided with an aperture able to house said rotation pin, wherein bushing means are provided with a seating for said rotation pin and are able to be disposed in said aperture, so that said seating assumes a determinate position, selectively adjustable, with respect to said fork, in order to consequently adjust also the position of said rotation pin with respect to said fork and the trail of said front wheel, wherein braking means is associated with at least one of said support elements, and wherein the position of said braking means with respect to said fork is correlated to the position of said seating and of said rotation pin with respect to said fork.

24. A clamping device as in claim 1, wherein said aperture has the form of an eyelet.

25. A clamping device as in claim 1, wherein said aperture is polygonal in shape.
